(19) United States
(12) Patent Application Publication
(10) Pub. No.: US 2005/0107095 A1
(43) Pub. Date: May 19, 2005

(54) Reporting a fault in a network for mobile telecommunications

(76) Inventor: Isaac Samuel, Swindon (GB)

Correspondence Address: Docket Administrator (Room 3J-219);Lucent Technologies Inc., 101 Crawfords Corner Road, Holmdel, NJ, 07733-3030, US

(21) Appl. No.: 10/714,788

(22) Filed: Nov. 17, 2003

(51) Int. Cl. H04Q 7/20

(52) U.S. Cl. 455/456.5

(57) ABSTRACT

A method is provided of reporting a fault to a control unit in a network for mobile telecommunications. The base station determines that a fault has been experienced by a mobile user terminal located within the cell served by the base station. The base station also determines the location of the mobile user terminal within the cell. The base station sends a report of the fault to the control unit, the report including information of the location within the cell served by the base station.

### FIELD OF THE INVENTION

The present invention relates to mobile telecommunications, and more particularly, to reporting a fault in a mobile telecommunications network.

### DESCRIPTION OF THE RELATED ART

Second generation networks are such as Global System for Mobiles (GSM), and third generation networks are code division multiple access (CDMA) networks such as CDMA2000 and Universal Mobile Telecommunications System (UMTS). In known second and third generation wireless telecommunications networks, faults experienced within the network are reported to a control point. More specifically, in such networks, a fault record indicating both that a fault has occurred in a cell and the type of fault is sent from a base station to its controlling base station controller. Information as to radio signal transmission characteristics is also sometimes included in the fault record. Such information can include, for example, block error rates in each direction between the mobile user terminal and a base station.

Usually, only the total number of each type of fault (e.g. call attempt, call failure, call drop) occurring in a cell in a specified period is reported up to the operation-and-maintenance centre (OMC) of the network. Accordingly, the human operator at the operation-and-maintenance centre (OMC) is provided with a table of totals of each type of fault in a particular period, e.g. the last hour or the last day. For example, the human operator is informed that there were 50 call drops in the cell of interest during the selected period. In addition, the operations-and-maintenance centre (OMC) can do some pre-programmed analysis of the radio signal transmission measurements so as to aid the human operator in planning and maintenance.

Since wireless networks are spread over large areas including entire countries, and even a single cell is typically 1 to 5 miles in radius, the operator is very dependent on the data reported back to operation-and-maintenance centre (ONIC) in order to monitor the behaviour of the network.

Once a significant set of faults is detected, skilled personnel go to the cell and make test call connections to mobiles and corresponding measurements of transmitted signals (e.g. radio frequency signal strength) in order to seek to identify the nature and location of the fault source more precisely within a cell, for example to locate an area with poor coverage, due to, for example, some unexpected scattering due to obstructions such as buildings and hills. The data collected from such a typical test session, known as a drive test, is then analysed (post-processed) to describe the cause of the faults and its precise location e.g. a particular building or a street corner.

### SUMMARY OF THE INVENTION

An embodiment of the present invention is a method of reporting a fault to a control unit in a network for mobile telecommunications. The base station determines that a fault has been experienced by a mobile user terminal located within the cell served by the base station. The base station also determines the location of the mobile user terminal within the cell. The base station sends a report of the fault to the control unit, the report including information of the location within the cell served by the base station.

Another embodiment of the present invention is a method of adjusting the functioning of a telecommunications network including the above-mentioned method of reporting a fault and the step of sending a response from the control unit to the base station, the response being an instruction to alter the functioning of the base station. The response is dependent upon the type and location of fault indicated in the report.

### BRIEF DESCRIPTION OF THE DRAWINGS

An embodiment of the present invention will now be described by way of example and with reference to the drawings, in which:

FIG. 1 is a diagram illustrating a UMTS wireless telecommunications network,

FIG. 2 is a diagram illustrating an example graphical display of fault information,

FIG. 3 is a diagram illustrating an example of use of the fault information as feedback to improve network performance,

### DETAILED DESCRIPTION

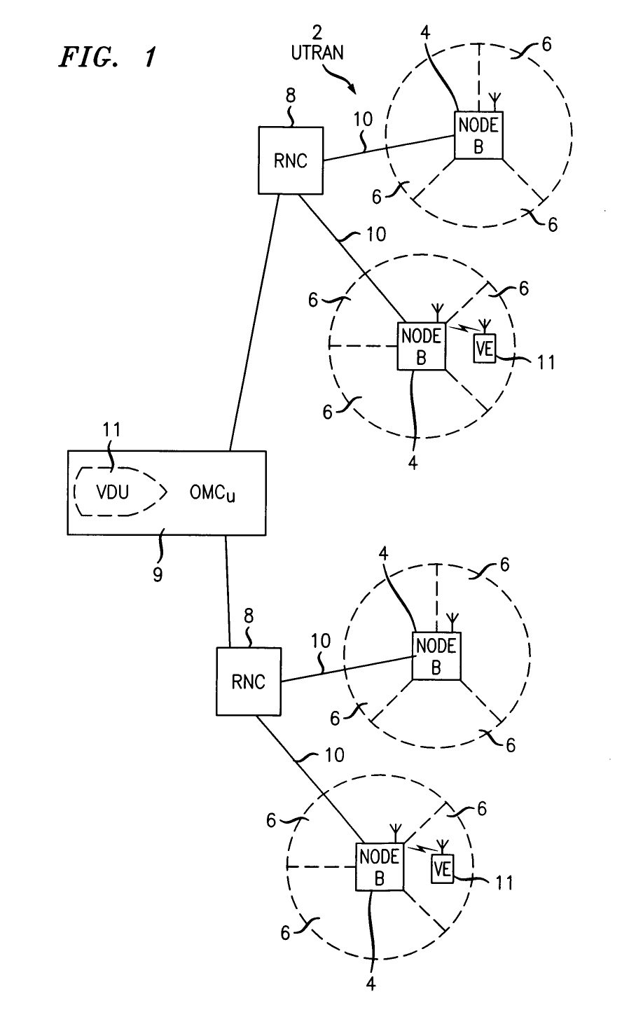

In the described embodiment, the mobile communications network is a Universal Mobile Telecommunications System (UMTS) terrestrial access network (UTRAN), which is a type of wideband code division multiple access (CDMA) network for mobile telecommunications. The UTRAN network is basically as shown in FIG. 1. Only two radio network controllers each controlling two base stations of the UTRAN network 2 are shown for simplicity. As shown in this Figure, the UTRAN network 2 includes base stations 4. Each base station (Node B in UMTS terminology) 4 typically has three cells 6 (i.e. radio coverage areas, also known as sectors) as the base station 4 typically has three directional antennas (not shown) angled at 120 degrees to each other in azimuth. Radio network controllers (RNC) 8 which are themselves connected to the rest of the telecommunications “world” (not shown) each control several base stations 4 and hence a number of cells 6. A base station 4 is connected to its controlling radio network controller (RNC) 8 via a respective interface 10 known as an IuB interface. In use, a mobile user terminal 12 (often referred to as User Equipment (UE) in UMTS terminology) communicates with a serving radio network controller (RNC) 8 via at least one cell 6 of at least one base station 4 (i.e. communicates with the UTRAN network 2).

The radio network controllers (RNC) 8 are also connected to an operation-and-maintenance centre 9 which includes a visual display unit 11. A human operator controls network functioning via the operation-and-maintenance centre 9.

Including Mobile User Terminal Location in a Fault Record

Geographic location within the cell of the mobile user terminal experiencing the fault is included in a fault record sent to a radio network controller. The location of the fault event is given to within a few metres. The fault record also includes the usual indication of the type of fault and radio signal transmission measurements.

In so-called third generation wireless networks such as UMTS networks, location of the mobile user terminal is known automatically by the network so as to enable location based services to be provided. The location of the mobile user terminal is determined by the network, specifically by the RNC, in response to requests made to the mobile user terminal that has requested a location-based service. The mobile user terminal provides enough information to the network, for example as to received signal strengths from various base stations, to enable the network to calculate the position of the mobile user terminal.

Alternatively, in another embodiment (not shown) otherwise similar to the first embodiment, mobile user terminals have GPS receivers built-in which directly supply the geographic coordinates of the mobile user terminal to the network.

When a fault occurs, the base station (NodeB) and its controlling Radio Network Controller (RNC) store the location of the mobile user terminal experiencing the fault together with an indication of the type of fault and radio signal transmission measurements in a fault record. Each record includes a timestamp. Table 1 below is an example fault record.

TABLE 1

| Record | | | | | | | | |
|---|---|---|---|---|---|---|---|---|
| #587 | | | BLER | | | | | |
| Timestamp | | BLER | Down | | | | | |
| 15:35:27 | Cell- | Uplink | link | | CPICH | Cause | | |
| UE Id | id | dB | dB | Ec/Io | RSCP | value | X Coord | Y Coord |
| Source | Cell | −0.13 | −0.78 | −5 dB | −75 | Abnor- | 1.00076 | 59.678 |
| | A | | | | dbm | mal call | | |
| | | | | | | termina- | | |
| | | | | | | tion | | |
| Active set | Cell | −5.1 | −5.12 | −4 dB | −72 | | 53.7071 | 23.2855 |
| | B | | | | dbm | | | |
| Active set | Cell | −4.33 | −4.75 | −7 dB | −80 | | 52.9669 | 24.0126 |
| | C | | | | dbm | | | |
| Monitored | Cell | | | −9 dB | −85 | | 52.7457 | 23.8804 |
| set | D | | | | dbm | | | |

As shown in Table 1, information is included in the fault record from the source cell (i.e. the cell to which the mobile experiencing the fault is located), from the cells in the active set of cells for handover(handoff) thereto, and from the set of cells (“monitored set”) monitored for prospective inclusion into the active set. Radio signal transmission information between the base station and mobile user terminal for which the fault occurred is also recorded along with a “cause value” indicating the type of fault.

More specifically, as shown in Table 1, the fault record includes a timestamp, identity (“cell-id”) of the source cell, the identity of cells in the active set, and can include the identity of one or more cells from the monitored set. For at least the source cell and cells of the active set (but possibly also one or more cells of the monitored set), X-Y location coordinates are included together with radio signal transmission data. The radio signal transmission data is: block error rate (BLER) in the uplink direction (that is from mobile user terminal to base station), block error rate (BLER) in the downlink direction (that is from base station to mobile user terminal), the ratio (denoted Ec/Io) of signal energy (chip energy) to energy of interference from other cells, common pilot channel received signal code power (CPICH RSCP), and the “cause value” which is one of a number of standard descriptors regarding the type of the fault.

These records are stored in the radio network controller (RNC) 8 for each fault event such as call drop, call setup failure, handover failure etc. The fault records are forwarded to the operations and maintenance centre (OMC) 9.

In an alternative embodiment (not shown) in addition to X-Y coordinate data, data in the Z-direction (i.e. height information above ground or some other height reference) is also included. This is known from Global Positioning System (GPS) location, for example.

Graphical Display

The fault record allows fault events to be pinpointed on a map. The operations and maintenance centre (OMC) 9 includes a visual display unit 11, and FIG. 2 is an example of the type of image which is shown on the visual display unit 11. As shown in FIG. 2, circles 12 indicating a “hotspot” area, namely an area from which several calls are blocked, are superimposed onto a street map 10. A further circle 14 is also shown indicates an area of interference resulting in call attempts failing. Yet further circles 16 indicate areas of call failure due to low signal strength (so-called “coverage holes”). In the image, each of several base stations is illustrated graphically by a symbol 18 consisting of three solid lines joined at a point on the map at which the base station is located. (Each of these solid lines represents one of three directional antennas directed 120 degrees apart in azimuth.)

Such a graphical display on a visual display unit allows practically instant appreciation of by the human operator of a problem in network performance. For example, hotspots are readily identified, allowing further cells (i.e. additional base stations) to be added, so as to better serve users of the mobile user terminals.

Use of Fault Records to Improve Network Operation

The network uses the information contained in the fault records as feedback for adjustment of the network to address problems. Consider for example a problem of interference at the boundary of a cell. The geographic coordinates in the fault records enable the radio network controller (RNC) 8 to automatically calculate the actual position of the interference. Assessment of the fault from the information using the fault record is undertaken at the operations and maintenance centre (OMC) 9 either by computer or by the human operator or a combination of both. An instruction for corrective action (in this case to reduce base station transmitted power) is then sent from the operations and maintenance centre (OMC) 9 to the radio network controller (RNC) 8 and on to the relevant base station 4.

The RNC 8 reduces the power transmitted by the base station 4 in steps. After each step the RNC 8 assesses, from the reduction in or absence of further fault records relating to the interference from that area, whether the interference has been prevented by that reduction of power.

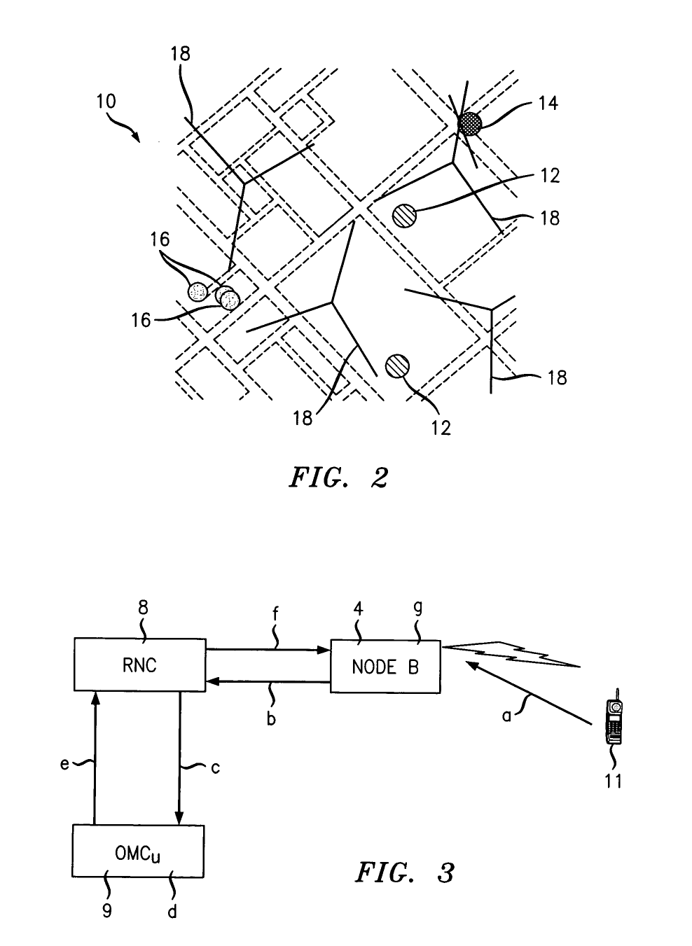

As shown in FIG. 3, dynamic steps are taken by the network, which includes the operations and maintenance centre (OMC) 9, radio network controller (RNC) 8, and base station (NodeB) 4, to avoid interference by using the location and radio signal transmission data. These are as follows:
(a) location and radio signal transmission measurements showing interference are reported by the mobile user terminal 11 to the base station 4,
(b) the measurements are forwarded from the base station 4 to the radio network controller 8,
(c) the measurements are forwarded from the radio network controller 8 to the operations and maintenance centre (OMC) 9,
(d) the measurement as are assessed at the operations and maintenance centre (OMC)
(e) an instruction to reduce transmit power is sent to RNC 8,
(f) the instruction to reduce transmitted power is forwarded to base station 4, and
(g) Transmit power from the base station 4 is reduced solving the interference issue.

1. A method of reporting a fault to a control unit in a network for mobile telecommunications, comprising the steps of:
at a base station:
determining that a fault has been experienced by a mobile user terminal located within a cell served by the base station,
determining the location of the mobile user terminal within the cell, and
sending a report of the fault to the control unit, the report including information of the location within the cell served by the base station.

2. A method according to claim 1, in which the information of the location is in the form of two dimensional coordinates (X-Y).

3. A method according to claim 1, in which the information of the location is in the form of three dimensional coordinates (X-Y-Z).

4. A method according to claim 1, in which the control unit includes a visual display unit, the method including indicating the location of the fault graphically on the visual display unit.

5. A method according to claim 1, in which the network is a code division multiple access (CDMA) network, and the base station comprises a base transmitter-receiver unit and a base station controller.

6. A method according to claim 5, in which the network is at least substantially in accordance with the Universal Mobile Telecommunications System (UMTS) standard, the base transmitter-receiver unit is a NodeB and the base station controller is a radio network controller (RNC).

7. A method of adjusting the functioning of a telecommunications network by: reporting a fault to a control unit in a network for mobile telecommunications, comprising the steps of:
a base station determining that a fault has been experienced by a mobile user terminal located within a cell served by the base station,
the base station determining the location of the mobile user terminal within the cell,
a base station sending a report of the fault to the control unit, the report including information of the location within a cell served by the base station; and
sending a response from the control unit to the base station, the response being an instruction to alter the functioning of the base station, the response being dependent upon the type and location of the fault indicated in the report.

8. A method according to claim 7, in which the response is decided upon and sent automatically by the control unit.

9. A method according to claim 7, in which the fault indicated is interference and the instruction is to reduce power of signals transmitted from the base station.

10. A network for mobile telecommunications comprising a base station and a control unit, the base station including means operative to determine that a fault has been experienced by a mobile user terminal located within a cell served by the base station, means operative to determine the location of the mobile user terminal within the cell, and means to send a report of the fault to the control unit, the report including information of the location of the mobile user terminal within the cell served by the base station.

11. A network according to claim 10, in which the control unit is operative to send a response to the base station, the response being an instruction to alter the functioning of the base station, the response being dependent upon the type and location of fault indicated in the report.
